(19) United States
(12) Patent Application Publication
(10) Pub. No.: US 2012/0025517 A1
(43) Pub. Date: Feb. 2, 2012

(54) Floor Drain Stabilizer Ring

(75) Inventors: Chistopher A. Majocka, Erie, PA (US); Douglas R. Wroblewski, Erie, PA (US); Mark A. Marini, Erie, PA (US); David Gomo, Lake City, PA (US)

(73) Assignee: ZURN INDUSTRIES, LLC, Erie, PA (US)

(21) Appl. No.: 13/191,929

(22) Filed: Jul. 27, 2011

Related U.S. Application Data
(60) Provisional application No. 61/368,118, filed on Jul. 27, 2010.

(51) Int. Cl. F16L 55/00

(52) U.S. Cl. 285/24; 285/27

(57) ABSTRACT

A stabilizing collar which is adapted to fasten to a drain pipe for stabilizing a drain and a stabilized drain and pipe assembly including drain having a receptacle body wherein the collar is adapted to fasten to the pipe at a location below the floor surface. The drain includes a receptacle including a plurality of downwardly opening bosses and the collar includes a plurality of bosses and at least one support member is adapted to be received within the bosses to stabilize the receptacle body relative to the stabilizing collar and the floor. Engagement members cooperate with adjustment members to adjust the diameter of the collar with respect to the pipe. The receptacle body is attached to the pipe and the support members are adjusted so that they contact the receptacle body and therefore provide support to keep the receptacle body at the same slope as the floor level.

### CROSS-REFERENCE TO RELATED APPLICATION

This application is based on U.S. Provisional Patent Application No. 61/368,118, filed Jul. 27, 2010, on which priority of this patent application is based and which provisional patent application is hereby incorporated by reference in its entirety.

### BACKGROUND OF THE INVENTION

1. Field of the Invention

The present invention relates generally to the installation of plumbing fixtures, and more particularly, to a method, apparatus and assembly for installing floor drains.

2. Description of Related Art

Unlike other types of plumbing fixtures, floor drains install directly into a concrete floor. Once installed, the rim of the fixture lies flush with the upper surface of the floor. In that position, liquid at floor level flows directly into the fixture and through an outlet at the bottom of the drain pipe beneath the floor. Such fixtures find widespread use and many floor drains appear in the concrete floors of buildings. Some of these buildings are many stories high and have many drains throughout.

Frequently, in multi-level buildings, the drain pipes extend through the incomplete skeleton structure. There is no floor to attach a stabilizing structure to make a drain “at grade”. The prior art stabilizing structure couples with the pipe and requires a floor for support for the pipe to further support the drain. In another application, after placing a sleeve over each drain pipe, the installer carefully fills the sleeves with sand to prevent collapse during the process of pouring the concrete floor. Once the sand is covering the drain pipe at each installation location, then workers can pour concrete and finish it at a predetermined floor level. The prior art installations involved time-consuming steps and is not possible in some situations. Therefore, a new and more efficient, less costly and less time-consuming way to install fixtures, such as floor drains, is sought.

### SUMMARY OF THE INVENTION

According to a first aspect, the present invention provides for a stabilizing collar which is adapted to fasten to a drain pipe for stabilizing a drain. The stabilizing collar includes a body having an outer surface and an inner surface. The inner surface of the body defines an opening for receipt of a pipe. The body defines an engagement member attached for securing the body to a pipe. The body further defines a support receiving portion adapted to receive a support member for supporting a drain on the stabilizing collar. The body may comprise a ring. Alternatively, the body may comprise segment. The support receiving portion may define a support receiving member which is integral with the body. The support receiving member may be in the form of a lug or boss, further defining a passageway therethrough. The support boss may include an engagement member to engage a support member. Alternatively, the support receiving member may further includes a threaded portion to coact with a threaded support member or it may not be threaded, in which case, a threaded ledge can hold a support member.

The body of the stabilizing collar may be a ring. An engagement member can be provided further including an adjustment member to contact a pipe. Alternatively, the stabilizing collar may define a segment having an adjustable diameter. A hinge may divide the segment and separate the stabilizing collar into two separate segments where the hinge attaches the two segments together. An engagement member may be present to adjustably press the two segment ends together, thereby adjusting the diameter. The stabilizing collar can further include a support member to coact with the support receiving members.

The support receiving members can be threaded support receiving members to receive threaded support members. Alternatively, a threaded support member can be received in a support receiving member where the support member is threadedly received by a threaded ledge. The threaded ledge can be a threadably adjusted nut that sits upon the support receiving member. In the alternative, the support receiving member can be sandwiched between two threadedly adjustable members threadedly attached to the support member. The inner surface of the stabilizing collar can define the pattern for providing a frictional connection between the stabilizing collar and the drain pipe. The stabilizing collar can be made of cast metal or plastic.

The present invention also provides for a stabilizing assembly for stabilizing a floor drain to a pipe. The stabilizing assembly includes a stabilizing collar and a receptacle body. The stabilizing collar, as discussed previously, has a body which has an outer surface and an inner surface defining an opening for adjusting the stabilizing collar to fit a pipe. The body further includes support receiving members for securing a support member for supporting the drain. Support members are received by the support receiving members and are attached to the body of the stabilizing collar and extend longitudinally from the stabilizing collar providing support for the receptacle body. The stabilizing assembly can further include a pipe, the opening in the body of the stabilizing collar adapted to secure to the pipe.

The present invention provides for a method of installing a stabilizing collar to stabilize a receptacle body of a drain. The method includes first providing a drain, the receptacle body thereof having a first end and a second end as in the previously discussed stabilizing collar assembly. Next, a stabilizing collar is coupled to a drain pipe. Then a support member is coupled to the stabilizing collar using one of several methods, such as an adjustment member received in an engagement member attached using a nut or threadable support members for coacting with threaded support receiving members. Next the receptacle body is attached to the pipe, leveled and the support members are adjusted so that at least one contacts the receptacle body and therefore provides support to keep the receptacle body at the same slope as the floor level. A further step includes concrete being poured onto the floor foundation while the stabilizing collar stabilizes the floor drain, thereby covering the stabilizing collar with the concrete.

According to a second aspect, the invention provides for a stabilizing collar for stabilizing a drain to a drain pipe wherein the drain pipe extends below a floor surface. The drain includes a receptacle body coupled to a support member. The receptacle body has a first portion, a second portion and a third portion located between the first and second portions. The receptacle body is configured such that the first portion can be located at or above the floor surface, and the second and third portions can be located below the floor surface and wherein the third portion includes downwardly opening bosses. The stabilizing collar comprises a body having an outer surface and an inner surface defining an opening configured for receipt of a portion of the drain pipe extending below the floor surface and an engagement member configured for cooperation with at least one adjustment member. The adjustment member can be adjustable with respect to a diameter of the drain pipe to secure the body on the drain pipe. The body defines a support receiving portion adapted to receive the support member coupled to the downwardly opening bosses within the third portion of the receptacle body of the drain so that the support member can support the drain on the stabilizing collar from beneath the floor surface. The support receiving member can comprise a plurality of bosses spaced apart radially along the outer surface of the body. According to one design, the plurality of bosses can comprise four bosses spaced at approximately 90° intervals about the support receiving member. Each of the bosses can include an engagement member and an adjustment member to engage the support member within the boss and the adjustment member is configured to adjust the diameter of the bosses. According to one design, the third portion of the receptacle body can comprise an underside of a flange of the receptacle body and the downwardly opening bosses can comprise threaded passageways that are drilled and tapped on the underside of a flange of the receptacle body.

The present invention also provides for a stabilizing assembly for stabilizing a floor drain to a pipe wherein the drain includes a receptacle body having a first portion, a second portion and a third portion positioned between the first portion and the second portion. The first portion of the receptacle body can be located at or above a floor surface and the second and third portions of the receptacle body can be located below the floor surface, wherein the second end of the receptacle body is adapted to fasten to the pipe at a location below the floor surface and the third portion includes downwardly opening bosses. The stabilizing collar, as discussed previously, has a body which has an outer surface and an inner surface defining an opening for adjusting the stabilizing collar to fit a pipe. An engagement member is associated with the body of the stabilizing collar and adapted to secure the body of the stabilizing collar on the pipe. The engagement member is configured for cooperation with at least one adjustment member wherein the adjustment member is adjustable with respect to a diameter of the pipe, and a support receiving portion is adapted to receive a support member to support the drain on the collar. At least one support member is provided for stabilizing the receptacle body relative to the stabilizing collar. The support member has a first end and a second end. The first end is configured for cooperation with the support receiving portion of the stabilizing collar at a location beneath the floor surface. The at least one support member longitudinally extends from the stabilizing collar such that the second end engages the downwardly opening bosses in the third portion of the receptacle body of the drain. According to one embodiment, the plurality of bosses can comprise four bosses spaced approximately 90° degrees apart about the circumference of the stabilizing collar. According to one design, the third portion of the receptacle body can comprise an underside of a flange of the receptacle body and the downwardly opening bosses can comprise four bosses for cooperating with the four bosses of the stabilizing collar and wherein the four downwardly opening bosses of the receptacle body include threaded passageways that are drilled and tapped on the underside of a flange of the receptacle body. The bosses and the engagement members with the adjustment members can be alternatingly interspersed about the stabilizing collar.

In addition, in a further step, a desired slope for a receptacle body is attained by adjusting the receptacle body to have a slope in accordance with the slope of a floor and the support members can be adjusted longitudinally to position the underside of the receptacle body causing the top of the receptacle body to attain a slope in conjunction with a floor level.

### BRIEF DESCRIPTION OF THE DRAWINGS

FIG. 1 is a top perspective view of a stabilizing collar made in accordance with the present invention;

FIG. 2 is a perspective view of a drain assembly including a drain pipe and a receptacle body in accordance with the present invention;

FIG. 3 is a top perspective view of another embodiment of a stabilizing collar made in accordance with the present invention;

FIG. 4 is a side elevational view, partly in section of the installed stabilizing collar of FIG. 3;

FIGS. 5A and 5B are top elevational views of a side-by-side comparison of the stabilizing collar shown in FIGS. 1 and 2 and another embodiment of a stabilizing collar made in accordance with the present invention; and

FIG. 6 is a perspective view of the installed stabilizing collar 200 shown in FIG. 5.

### DESCRIPTION OF THE PREFERRED EMBODIMENTS

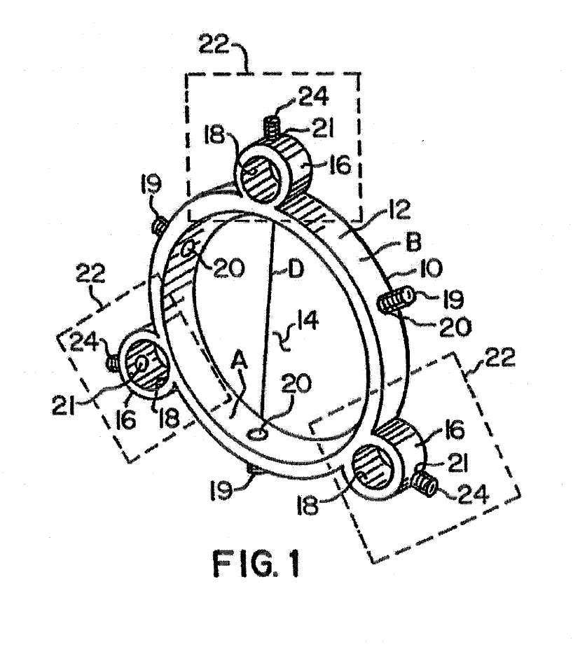

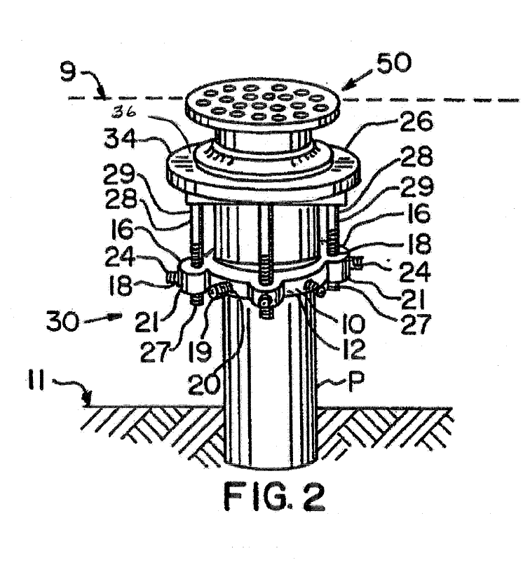

Referring to FIGS. 1 and 2, the present invention is a stabilizing collar 10 used to support a receptacle body 26 of a prior art floor drain. The stabilizing collar 10 includes a ring-shaped body 12 having an inner surface A and an outer surface B. The inner surface A of the stabilizing collar 10 of the body 12 defines an opening 14 having a diameter D. The body 12 of the stabilizing collar 10 defines threaded holes 20 acting as engagement members, a plurality of which, are spaced radially along the outer surface B of body 12, which receive threaded fasteners 19 acting as adjustment members, preferably screws or set screws. In this case, three threaded holes 20 are provided spaced 120° apart. The body 12 of the stabilizing collar 10 further defines support receiving portions 22 (shown in phantom), which include a plurality of axially opened bosses 16 acting as engagement members, integral to body 12 and spaced apart radially along the outer surface B of body 12 of the stabilizing collar 10. In this case, three bosses 16 are provided, spaced 120° apart. The bosses 16 and the threaded holes 20 are circumferentially offset from each other. The axially opened bosses 16 define a passageway 18. The axially opened bosses 16 further define threaded holes 21, engagement members which receive threaded fasteners 24, preferably screws or set screws acting as adjustment members, which adjust into the axially opened bosses 16 in order to contact support members 28, which are received by passageways 18, thereby securing support members 28 of stabilizing collar 10. In another embodiment, not shown, the axially opened bosses can define threaded passageways for threadedly receiving, attaching and securing threaded support members. With further reference to FIG. 1, the stabilizing collar 10 can be made of plastic, cast iron, or other metals or polymeric materials.

FIG. 2 shows a floor drain support assembly 30 that includes a receptacle body 26 of a drain 50 coupled to a support collar 10 coupled to support members 28 and pipe P. Pipe P can be made of any material including, but not limited to, cast iron pipe, steel pipe, plastic pipe, extra heavy soil pipe and service weight pipe. The stabilizing collar 10 which has a diameter D greater than a diameter of pipe P is attached to pipe P when a threaded fastener 19 (such as a screw or a set screw), received by threaded holes 20 and threadably adjusted into threaded holes 20 until it contacts the outer surface of pipe P thereby securing stabilizing collar 10 to pipe P. Receptacle body 26 has a bottom end 34, which is attached to pipe P. Support members 28 having a first end 27 are secured to the stabilizing collar 10 via the passageways 18 of the axially opened bosses 16. Support members 28 can be made from threaded rod or rebar.

With continuing reference to FIG. 2, the first end 27 of support members 28 are received by passageways 18 of axially opened bosses 16 and the threaded fasteners 24 are adjusted into the engagement members 21 to contact and secure the support members 28. Alternatively, support members (not shown) may have threadedly adjustable first ends for coacting with threaded passageways of support receiving members and can be threadedly attached. The second end 29 of support members 28 are placed in contact with receptacle body 26 of drain 50. Receptacle body 26 can have downwardly opening bosses (not shown) for contacting the second end 29 of the support members 28. The support drain body 26 can be, for example, a Zurn Z415-B drain. As shown in FIG. 2, axially opened bosses 16 are integral to the body 12 of stabilizing collar 10. After the support members 28 are attached to the stabilizing collar 10 which is attached to pipe P and the receptacle body 26 is placed onto the second end 29 of support members 28, concrete can be poured around drain 50 to a floor level 9 covering the floor drain support assembly 30 to the level of a floor foundation 11. Typically, the floor drain pipe assembly extends above ground level or at grade. A portion of the drain 50 can be encased in concrete. The stabilizing collar 10 acts to stabilize drain 50 during the installation process.

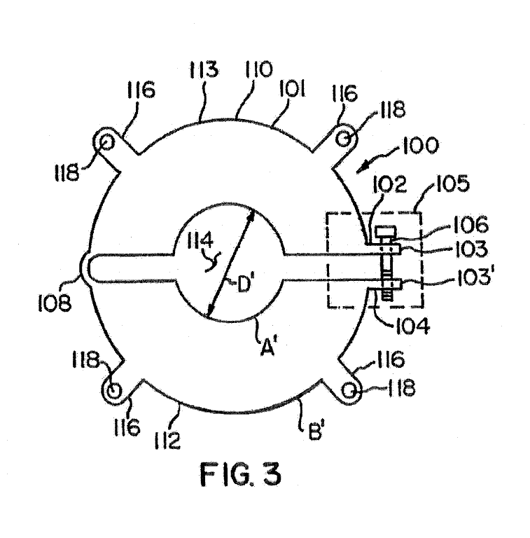

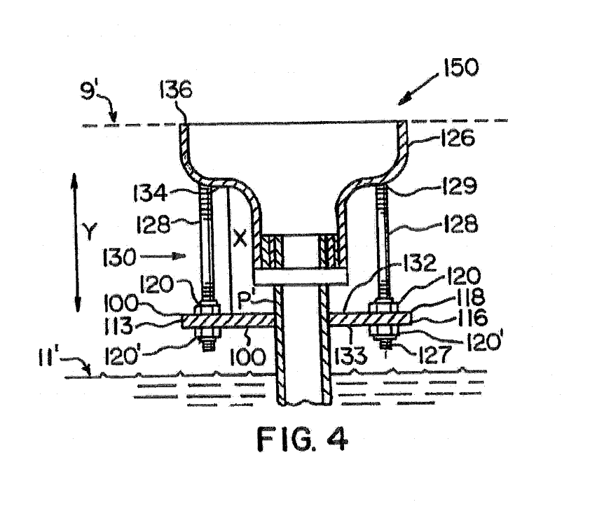

FIGS. 3 and 4 show a second apparatus having an inner surface A′ and an outer surface B′. A stabilizing collar 100 includes a body 113 in the form of an arcuate segment 101. The arcuate segment 101 can be divided into a first arcuate segment 110 and a second arcuate segment 112 with a hinge 108 positioned therebetween. Inner surface A′ of body 113 defines an opening 114 having a diameter D′. An engagement member 105 can include a passageway 103 and 103′ (shown in phantom) through a first end 102 of first arcuate segment 110 and a first end 104 of second arcuate segment 112, respectively, for receiving a threaded fastener 106 acting as an adjustment member. The threaded fastener 106, preferably a screw or set screw, is adjusted to change the diameter D′ of the body 113 of stabilizing collar 100 to attach to a pipe P′. The body 113 of the stabilizing collar 100 defines lugs 116 acting as support receiving members. As shown in FIGS. 3 and 4, lugs 116 having a passageway 118. The inner surface A′ defines a pattern to provide frictional support between the body 113 of the stabilizing collar 100 and the pipe P′.

FIGS. 3 and 4 further show a second floor drain support assembly 130 having a drain receptacle body 126 having a top end 136 and a bottom end 134 and a stabilizing collar 100 (not shown to scale). The stabilizing collar 100, as previously discussed, has an engagement member 105 for adapting stabilizing collar 100 to attach to pipe P′. A support member 128 having a threaded first end 127 is received by passageway 118 of support receiving member 116. The support member 128 is threaded and attached to the body 113 of stabilizing collar 100 after first end 127 is passed through support receiving member 116 by attaching a nut 120 positioned adjacent a top surface 132 of body 113 forming a threaded ledge. The support member includes a second end 129. A washer (not shown) can be further positioned between the nut 120 and the body 113. A second nut 120′ can be positioned adjacent a bottom surface 133 of body 113 sandwiching the support receiving member 116 between first nut 120 and second nut 120′. The distance X between the receptacle body 126 can be adjusted by moving nuts 120 and 120′ longitudinally along the threaded support member 128. The bottom end 134 of receptacle body 126 is resting on the support members 128.

Stabilizing collar 100 is fastened to pipe P′ when the engagement member 105 is adjusted to secure stabilizing collar 100 to the pipe P′ by screwing adjustment member 106, which is preferably a threaded thumbscrew until the first end 102 at first segment 110 abuts first end 104 of second segment 112 and diameter D′ of stabilizing collar 100 is adapted to secure to a diameter of pipe P′. The pipe P′ can also be a part of the second floor drain support assembly 130. Floor drain receptacle body 126 is also adapted to attach to a pipe P′. Typically, the floor drain pipe assembly extends above ground level or at grade. A portion of the second floor drain support assembly 130 can be encased in concrete. The stabilizing collar 100 acts to stabilize the second floor drain support assembly 130 during the installation process.

The present invention provides a method for stabilizing a floor drain to a pipe P′. The receptacle body 126 is provided having a first end 136 and a second end 134. A stabilizing collar 100 is provided, the stabilizing collar 100 having the features as discussed previously. The opening 114 of the stabilizing collar 100 is placed over pipe P′ and engagement member 105 is adjusted to attach the stabilizing collar 100 to pipe P′. Next, the support members 128 are coupled to the stabilizing collar 100.

The support members 128 of the body 113 of stabilizing collar 100 are coupled to the support receiving members 116 when passed through the passageways 118. For attachment as shown in FIG. 4 to occur, a first adjustable member 120, preferably a nut, is fastened to the support member 128 and a first end 127 of the support member 128 is received within the passageway 118 and the passageway 118 of the body apparatus 113. The support member 128 passes through the passageway 118 and support receiving member 116 wherein the first adjustable member 120 abuts against the top surface 132 of the body 113 of the stabilizing collar 100. A distance X between the receptacle body 126 and the stabilizing collar 100 can be increased or decreased by longitudinally moving the first adjustable member 120 in either direction, represented by arrow Y along the support member 128. Once the distance X is determined, a second adjustable member 120′ is fastened onto the support member 128 at the first end 127 and moved toward the bottom surface 133 of the body 113 of the stabilizing collar 100, thereby fixing the distance X between the receptacle body 126 and the stabilizing collar 100. The distance X can still be adjusted by longitudinally moving both adjustable members 120, 120′ along the support member 128.

Alternatively, as shown in FIG. 2, the support members 28 are received by passageways 18 of axially opened bosses 16 and secured with fastener members 24, which are received into engagement members 21 and adjusted until the support members 28 are contacted by the fastener members 24.

In FIG. 4, once the support members 128 are attached to the stabilizing collar 100, the bottom end 134 of drain receptacle body 126 is attached to pipe P′. Next, the receptacle body 126 is leveled. Then, the support members are longitudinally adjusted, as previously described, until they contact bottom end 134 of receptacle body 126, thereby stabilizing the receptacle body 126 in its level position. The receptacle body 126 can have a boss for contacting a support member 128. The receptacle body 126 is rotated until contact occurs between at least one support member 128 and the receptacle body boss. The receptacle body 126 is checked to determine it is still leveled after the prior adjustments, if not it can be leveled again as many times as necessary. Each time the receptacle body 126 is leveled, the steps including adjustment of the support members 128 and rotating the receptacle body 126 to contact the support members 128 are repeated.

Once the receptacle body 126 is level and stabilized by the support members 128, a concrete mixture can be poured around the floor drain assembly 130 covering the floor foundation 11′ until a floor level 9′ has been reached.

In addition to providing stabilization, the present invention provides for a support member to slope the receptacle body 126. Sloping can take place by adjusting the support members 128 once they have been attached to the stabilizing collar 100. The top surface 136 of receptacle body 126 is sloped to match a floor level 9′, then support members 128 are longitudinally adjusted to contact the bottom end 134 of receptacle body 126 in the sloped position so that it rests upon the support members 128 in such a way as to slope the top end surface 136 of the receptacle body 126. The top end surface 136 having a slope that matches the slope of floor level 9′.

Similarly, the floor drain support assembly 30 in FIG. 2 can be leveled or sloped, depending on the adjustment of the support members 28. Once the receptacle body 26 is attached to the pipe P, the top surface 36 of receptacle body 26 is sloped to match floor level 9. Alternatively, the top surface 36 of receptacle body 26 is leveled. Then support members 28 are longitudinally adjusted to contact the bottom end 34 of the receptacle body 26. Leveling the receptacle body 26, adjusting the support members 28 and rotating the receptacle body 26 can be repeated.

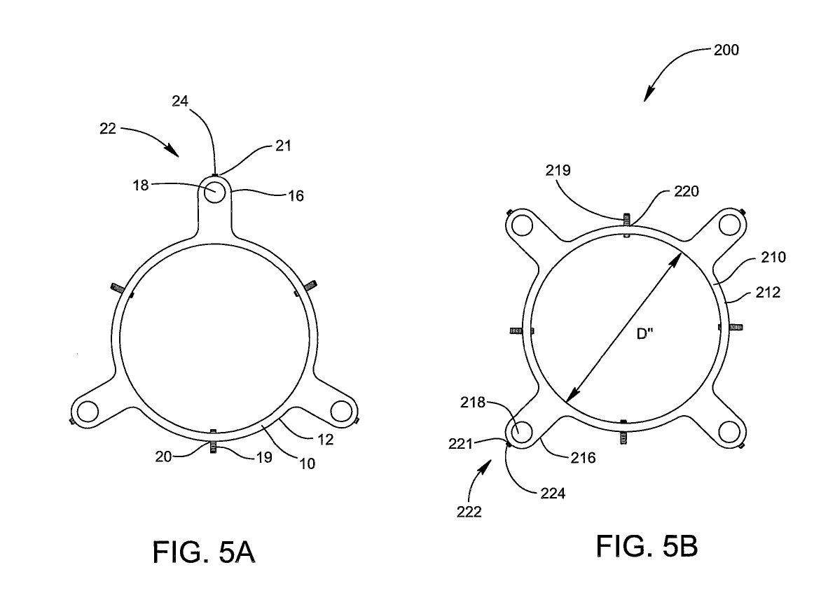

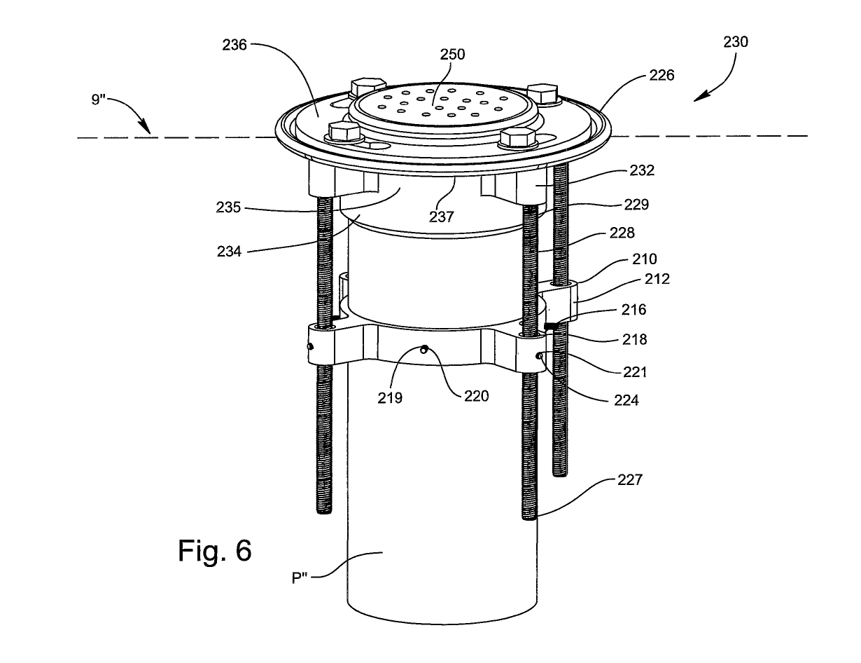

FIGS. 5A and 5B are top elevational views of a side-by-side comparison of the stabilizing collar shown in FIGS. 1 and 2 and another embodiment of a stabilizing collar made in accordance with the present invention. The stabilizing collar shown in FIG. 5A is a top elevational view of the stabilizing collar of FIG. 1, which is discussed in detail above. Referring in particular to FIGS. 5B and 6, the other embodiment 200 of the present invention is now described. Stabilizing collar 210 includes ring-shaped body 212 defining a plurality of threaded holes 220 acting as engagement members which are spaced radially along the outer surface of body 212. Holes 220 receive threaded fasteners 219 acting as adjustment members, preferably screws or set screws. In this case, four threaded holes 220 are provided spaced 90° apart. The body 212 of the stabilizing collar 210 further defines support receiving portions 222, which include a plurality of axially opened bosses 216 acting as engagement members, integral to body 212 and spaced apart radially along the outer surface of body 212 of the stabilising collar 210. In this case, four bosses 216 are provided, spaced 90° apart. The bosses 216 and the threaded holes 220 are alternatingly located and/or circumferentially offset from each other. The axially opened bosses 216 define a non-threaded passageway 218. In another embodiment, the axially opened bosses 216 can define threaded passageways 218 for threadably receiving, attaching, and securing threaded support members 228. The axially opened bosses 216 further define threaded holes 221 acting as engagement members which receive threaded fasteners 224, preferably screws or set screws acting as adjustment members. Fasteners 224 adjust into the axially opened bosses 216 in order to contact support members 228, which are received by passageways 218, thereby securing support members 228 of stabilizing collar 210.

FIG. 6 shows a floor drain support assembly 230 that includes a receptacle body 226 of a drain 250 coupled to stabilizing collar 210, support members 228, and pipe P″. The drain 250 can be configured to receive a perforated drain cover. The receptacle body 226 has a first portion 236, a second portion 234 and a third portion 235 located between the first portion 236 and the second portion 234. The receptacle body 226 can be configured such that the first portion 236 is located at or above the floor surface 9″ and the second portion 234 and the third portion 235 can be located below the floor surface 9″. The stabilizing collar 210, which has a diameter D″ greater than a diameter of pipe P″, is attached to pipe P″ when a threaded fastener 219 (such as a screw or a set screw) is received by threaded holes 220 and threadably adjusted into threaded holes 220 until it contacts the outer surface of pipe P″ thereby securing stabilizing collar 210 to pipe P″. Receptacle body 226 has a bottom end 234, which is attached to pipe P″. Support members 228 having a first end 227 are secured to the stabilizing collar 210 via the passageways 218 of the axially opened bosses 216.

With continuing reference to FIG. 6, the first end 227 of support members 228 are received by passageways 218 of axially opened bosses 216 and the threaded fasteners 224 are adjusted into the engagement members 221 to contact and secure the support members 228. Alternatively, support members 228 may have threadedly adjustable first ends 227 for contacting with threaded passageways 218 of stabilizing collar 210 and can be threadedly attached. Receptacle body 226 can have downwardly opening bosses 232 that have been drilled and tapped into the third portion 235 of the receptacle body 226 for receiving the second end 229 of the support members 228. The downwardly opening bosses 232 can be spaced apart radially along the underside of a flange 237 of the receptacle body 226. In this case, four bosses 232 are provided, spaced 90° apart, and are aligned with the four bosses 216 of the stabilizing collar 210. The second end 229 of support members 228 are threadedly attached to bosses 232 of receptacle body 226. The stabilizing collar 210 and pipe P″ can be subsequently embedded in concrete.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

The invention claimed is:

1. A stabilizing collar for stabilizing a drain to a drain pipe, said drain pipe extending below a floor surface, wherein the drain includes a receptacle body coupled to a support member, said receptacle body having a first portion, a second portion and a third portion located between said first and second portions, and wherein said receptacle body is configured such that the first portion can be located at or above the floor surface, and the second and third portions can be located below the floor surface and wherein said third portion includes downwardly opening bosses, said stabilizing collar comprising:
a body having an outer surface and an inner surface defining an opening configured for receipt of a portion of the drain pipe extending below the floor surface; and
an engagement member configured for cooperation with at least one adjustment member, said adjustment member being adjustable with respect to a diameter of the drain pipe to secure said body on the drain pipe;
the body defining a support receiving portion adapted to receive the support member coupled to the downwardly opening bosses within the third portion of the receptacle body of the drain so that the support member can support the drain on the stabilizing collar from beneath the floor surface.

2. The stabilizing collar as recited in claim 1, wherein the support receiving portion includes a support receiving member.

3. The stabilizing collar as recited in claim 1, wherein the body comprises a ring.

4. The stabilizing collar as recited in claim 1, wherein the body comprises a segment.

5. The stabilizing collar as recited in claim 2, wherein the support receiving member is integral with the body.

6. The stabilizing collar as recited in claim 2, wherein the support receiving member is a lug defining a passageway.

7. The stabilizing collar as recited in claim 2, wherein the support receiving member comprises a plurality of bosses spaced apart radially along the outer surface of the body.

8. The stabilizing collar as recited in claim 7 wherein the plurality of bosses comprises four bosses spaced at approximately 90° intervals about the support receiving member.

9. The stabilizing collar as recited in claim 7, wherein each of the bosses include an engagement member and an adjustment member to engage said support member within the boss and wherein the adjustment member is configured to adjust the diameter of the bosses.

9. The stabilizing collar as recited in claim 7, wherein the support member is threaded and each of the bosses further include a threaded passageway to coact with the threaded support member.

10. The stabilizing collar as recited in claim 1, wherein the third portion of the receptacle body comprises an underside of a flange of the receptacle body and wherein the downwardly opening bosses comprise threaded passageways that are drilled and tapped on the underside of a flange of the receptacle body.

11. The stabilizing collar as recited in claim 10, wherein the support receiving member is a lug defining a threaded passageway, wherein a threaded support member is threadably attached.

12. The stabilizing collar as recited in claim 1, wherein the stabilizing collar is made of cast metal or plastic.

13. A stabilized drain and pipe assembly comprising:
a pipe received by a drain, the drain having a receptacle body, the receptacle body having a first portion, a second portion and a third portion positioned between the first portion and the second portion, the first portion of the receptacle body being located at or above a floor surface and the second and third portions of the receptacle body being located below the floor surface, the second end of the receptacle body adapted to fasten to the pipe at a location below the floor surface and the third portion including downwardly opening bosses;
a stabilizing collar having a body having an outer surface and an inner surface defining an opening configured for receipt of the pipe, an engagement member associated with the body of the stabilizing collar and adapted to secure the body of the stabilizing collar on the pipe, said engagement member configured for cooperation with at least one adjustment member, said adjustment member being adjustable with respect to a diameter of the pipe, and a support receiving portion adapted to receive a support member to support the drain on the collar; and
at least one support member for stabilizing the receptacle body relative to the stabilizing collar, the support member having a first end and a second end, said first end configured for cooperation with the support receiving portion of the stabilizing collar at a location beneath the floor surface, said at least one support member longitudinally extending from the stabilizing collar such that said second end engages the downwardly opening bosses in the third portion of the receptacle body of the drain.

14. The assembly as recited in claim 13, wherein:
the opening of the stabilizing collar is configured for receiving said pipe and wherein the stabilizing collar can be secured to the pipe.

15. The assembly as recited in claim 13 wherein the third portion of the receptacle body comprises an underside of a flange of the receptacle body and wherein the downwardly opening bosses comprise threaded passageways that are drilled and tapped in the underside of a flange of the receptacle body.

16. The assembly of claim 13 wherein the support receiving member comprises a plurality of bosses spaced apart radially along the outer surface of the body.

17. The assembly of claim 16 wherein the plurality of bosses comprise four bosses.

18. The assembly of claim 17 wherein the body comprises a ring and wherein the four bosses are spaced at approximately 90° intervals about said ring.

19. The assembly of claim 18 wherein each of the bosses include an engagement member and an adjustment member to engage said support member with the bosses.

20. The assembly of claim 13 wherein the drain is configured to receive a perforated drain cover.

21. The assembly of claim 13, wherein the collar and pipe are subsequently embedded in concrete.

22. A stabilized drain and pipe assembly comprising:
a pipe received by a drain, the drain having a receptacle body, the receptacle body having a first portion, a second portion and a third portion located between the first portion and the second portion, the first portion located at or above a floor surface and the second and third portions located below the floor surface, the second portion of the receptacle body adapted to fasten to the pipe at a location below the floor surface;
a stabilizing collar having a body having an outer surface and an inner surface defining an opening configured for receipt of the pipe and an engagement member associated with the body of the stabilizing collar and adapted to secure the body of the stabilizing collar on the pipe, said engagement member configured for cooperation with at least one adjustment member, said adjustment member being adjustable with respect to a diameter of the pipe;
four bosses spaced apart radially along the outer surface of the stabilizing collar;
a plurality of support members, each of said support members having a first end and a second end, said first end configured for cooperating with one of said bosses, and said second end being coupled to the second end of the receptacle body of the drain.

23. The assembly of claim 22 wherein the third portion includes a plurality of downwardly opened bosses formed therein for cooperating with the second end of the support members.

24. The assembly of claim 23 wherein the third portion of the receptacle body comprises an underside of a flange of the receptacle body and wherein the downwardly opening bosses comprise threaded passageways that are drilled and tapped in the underside of a flange of the receptacle body.

25. The assembly of claim 22, wherein the engagement member comprises a plurality of openings spaced apart radially along the outer surface of the body and the at least one adjustment member comprises a plurality of set screws cooperating with the openings.

26. The assembly of claim 25 wherein the bosses and the engagement members with the adjustment members are alternatingly interspersed about the stabilizing collar.

27. The assembly of claim 22, wherein the drain is configured to receive a perforated drain cover.

28. The assembly of claim 22, wherein the collar and pipe are subsequently embedded in concrete.

29. The assembly of claim 25, wherein the plurality of set screws are adjustably movable within said plurality of openings into contact with the pipe to secure the stabilizing collar to the pipe.

30. The assembly of claim 22, wherein the stabilizing collar is made of cast metal or plastic.
